(19) United States
(12) Patent Application Publication
(10) Pub. No.: US 2008/0055403 A1
(43) Pub. Date: Mar. 6, 2008

(54) PCB Board For Hybrid Circuit Of An Image Sensor

(75) Inventors: Golan Salman, Atlit (IL); Leonid Krivopisk, Nesher (IL); Amram Aizenfeld, Kibbutz Ramot Menashe (IL); Shai Brenner, Haifa (IL)

Correspondence Address: BRUCE E. LILLING;LILLING & LILLING PLLC, P.O. BOX 560, GOLDEN BRIDGE, NY, 10526, US

(73) Assignee: STRYKER GI LTD., Caesarea (IL)

(21) Appl. No.: 11/847,104

(22) Filed: Aug. 29, 2007

Related U.S. Application Data
(60) Provisional application No. 60/824,331, filed on Sep. 1, 2006.

(51) Int. Cl. H04N 7/18

(52) U.S. Cl. 348/76; 348/E07.085

(57) ABSTRACT

A printed circuit board (PCB) for deployment of a sensor chip of an optical head of an endoscope is described. The PCB comprises at least one layer defined by a front surface, a rear surface and a recess provided on said front surface. The recess has a depth dimension and the sensor chip has a thickness corresponding to said depth dimension of the recess. The sensor chip is receivable within the recess so as to be essentially flush with the front surface of the PCB. The PCB comprises at least one bonding pad located at a predetermined distance from the sensor chip and is electrically connectable with the sensor chip.

### FIELD OF THE INVENTION

The present invention relates generally to the field of endoscopy and specifically to an optical head for use with an endoscope. More particularly, the present invention refers to a printed circuit board for the optical head used in the endoscope.

### BACKGROUND OF THE INVENTION

There are known various endoscopic apparatuses employing optical heads for visualization of the interior of the body cavity or lumen. Essential parts of such optical heads are the imaging system and illumination system. The imaging system might comprise an objective lens at the distal end of the endoscope and an eyepiece at the proximal end of the endoscope to observe the interior of the lumen with the eye.

The illumination system serves for transmitting light to the distal end of the endoscope to illuminate the location to be observed. Such illumination system might be either external light sources, e.g. xenon or halogen light sources with a fiber optic bundle for submitting light energy from light source to endoscope distal tip or be internal light sources, e.g. light emitting diodes (LED's) located within the endoscope.

Aizenfeld (International Patent Publication No. WO 2006/025058) describes an optical head for an endoscope, fitted with an imaging system comprising a solid state imaging sensor and with an illuminating system comprising illuminating means, e.g. LED's. At least one illuminating means is defined by a parameter, which value is different from the value of the same parameter of the remaining illuminating means. Among the parameters are luminous intensity, luminous intensity distribution angle and direction of the longitudinal axis of the illuminating means.

In the modern endoscopic devices the imaging system comprises an imaging optic and a solid state imaging sensor, e.g. in the form of a charge coupled device CCD (charge coupled device)-chip or CMOS (complementary metal oxide semiconductor), which transforms the light signals reflected from the object into electric signals, passing to the proximal end via electric lines and visually presented, as a real image, on an image reproduction unit outside the endoscope.

In such endoscopic devices, electronic circuits are provided. Typically, an electronic circuit is installed inside of an optical head of the endoscope in the form of a sensor chip, which is electrically connected to a printed circuit board (PCB). The conventional PCB is configured as a substrate having a flat surface. The PCB dimensions affect the diameter of the optical head and thus limit the possible miniaturization of the optical head, which is always desirable.

Several approaches have been used to reduce the size of the optical head and its different portions. For example, Takami (U.S. Pat. No. 6,898,086) discloses a printed circuit board structure for a scope unit of an electronic endoscope system, which is provided with a first printed circuit board formed with a first circuit section, and a second printed circuit board formed with a second circuit section.

Sonnenschein (International Patent Publication No. WO 2005/115221) discloses a reusable miniature camera head that can be attached to and detached from an object.

There are several factors that may influence the size of the PCB. One of the factors is the distance between the sensor chip situated on the PCB and the bonding pads, to which the sensor chip is connected by electrical wires. For the sake of brevity the sensor chip will be referred-to in the further disclosure simply as chip.

The wire bonding is usually accomplished by a nozzle of a wire bonding machine. Thus, the distance between the chip and the pads should be wide enough to allow the nozzle to reach the bonding location without touching the chip.

FIG. 5A illustrates a bonding process for electrically connecting a chip 53 with a pad 57 of a PCB 55. The bonding is carried out by a nozzle 51 of a bonding machine. The nozzle has a radial dimension R. The distance D₁ (usually about 0.45 mm) between the chip 53 and the pad 57 should be determined so that the periphery 59 of the nozzle 51 will not touch the chip 53, i.e. D₁>R. Therefore, the size of the PCB can not be reduced below a certain critical size, dictated by the distance between the chip and the bonding pads. However, this limitation is critical for optical heads of endoscopes, in which it is desirable to reduce the overall diameter of the probe.

### SUMMARY OF THE INVENTION

In accordance with one aspect of the present invention, there is provided a printed circuit board (PCB) for an optical head of an endoscope, the PCB comprising a front surface, a rear surface and a recess provided on said front surface and having a predefined depth dimension; a sensor having a thickness corresponding to said depth dimension of the recess, adaptable to be received within the recess so as to be essentially flush with said front surface; at least one bonding pad provided on the PCB at predetermined distance from the sensor; and electrical wires connecting the sensor to the bonding pad. The recess of the PCB has length and width dimensions greater than corresponding length and width dimensions of the sensor, so as to create a margin between the sensor and the PCB when the sensor is received in the recess.

According to another embodiment of the present invention, the PCB may further comprise at least two layers, one being a top layer and other being a bottom layer, said top layer having a cut-out defining said recess. In such case, the sensor has a thickness corresponding to the thickness of the top layer. The PCB may have a U-shape configuration.

The sensor, which may be in a form of a CCD-chip, may further comprise at least one bonding lead connected with the corresponding bonding pad by the electrical wires.

According to a further aspect of the present invention, there is provided an optical head for an endoscope having a printed circuit board (PCB), comprising a front surface, a rear surface and a recess disposed on said front surface and having a predefined depth dimension; a sensor having a thickness corresponding to said depth dimension of the recess, adaptable to be received within the recess so as to be essentially flush with said front surface; at least one bonding pad mounted on the PCB at predetermined distance from the sensor; and electrical wires connecting the sensor to the bonding pad.

According to a further aspect of the present invention, there is provided an endoscope having an optical head, comprising a printed circuit board (PCB), the PCB comprises a front surface, a rear surface and a recess disposed on said front surface and having a predefined depth dimension; a sensor having a thickness corresponding to said depth dimension of the recess, adaptable to be received within the recess so as to be essentially flush with said front surface; at least one bonding pad mounted on the PCB at a predetermined distance from the sensor; and electrical wires connecting the sensor to the bonding pad.

According to a further aspect of the present invention, there is provided a method of connecting a sensor having a predetermined thickness to a printed circuit board (PCB) having a front surface and a rear surface, the method comprising: providing a recess disposed on said front surface and having a predefined depth dimension, corresponding to said thickness; mounting the sensor within the recess so that the sensor is essentially flush with said front surface; providing at least one bonding pad on said front surface of the PCB at a predetermined distance from the sensor; and connecting the sensor to the bonding pad by electrical wires.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an isometric view of a printed circuit board (PCB) according to the present invention;

FIG. 2 is a front view of the PCB seen in FIG. 1, together with a chip received therein;

FIG. 3 is an isometric view of the PCB according to another embodiment of the invention;

FIG. 4 is an isometric view of the PCB seen in FIGS. 1 and 2;

FIG. 5A is a schematic illustration of a prior art wire bonding process;

FIG. 5B is a schematic illustration of a wire bonding process according to the present invention;

FIG. 6 is an isometric view of yhe main components of an optical head shown in FIG. 7; and

FIG. 7 is an isometric view of an optical head.

### DETAILED DESCRIPTION OF PREFERRED EMBODIMENTS

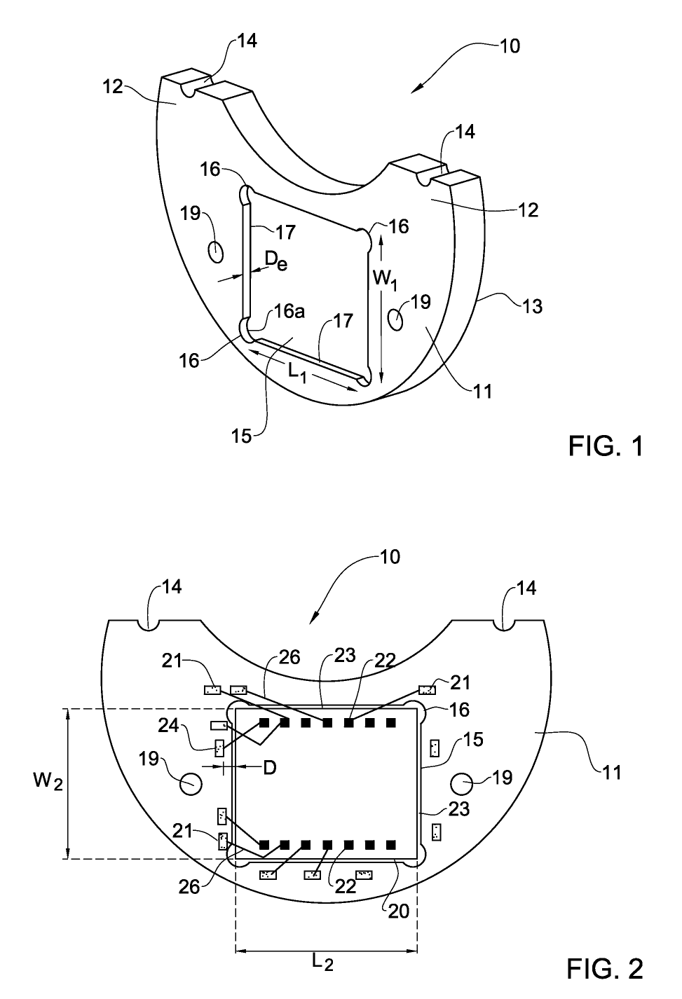

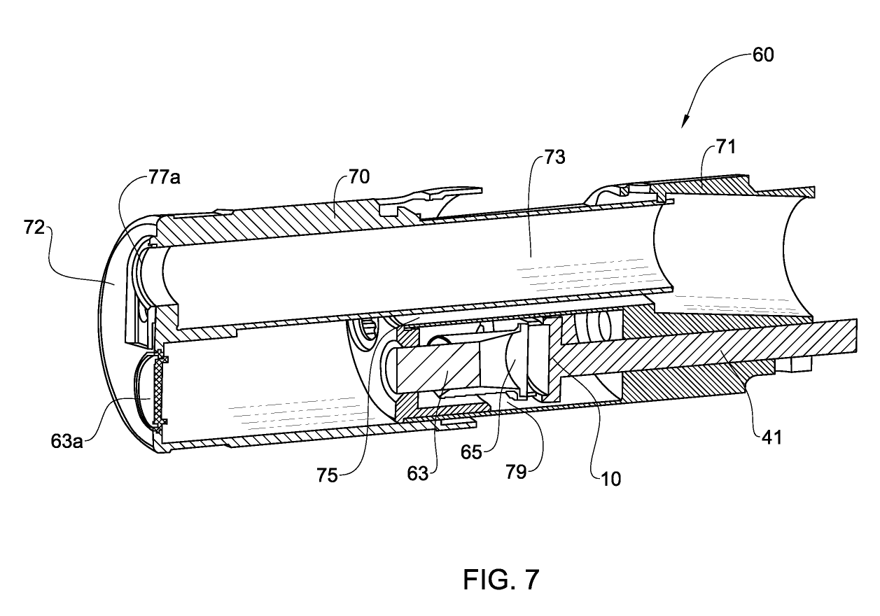

FIG. 1 illustrates a PCB generally designated 10 for use with an optical head 60 (shown in FIG. 7) of an endoscope. The PCB 10 comprises a front surface 11, a rear surface 13 and a recess 15 provided on the front surface 11. The recess 11 has a length L₁ and a width W₁ and is defined by four inner side walls 17. The recess has a depth Dₑ. The PCB further comprises a couple of alignment openings 19 at both sides of the recess 15, and a couple of through going openings 14 located at the upper edges 12 of the PCB 10. The PCB has a U-shape configuration, as will be further explained. The recess 15 has a square configuration, obtained by milling, cutting or any other suitable machining process. The recess 15 may also have corners 16 provided with small radii 16a, created during the manufacturing process.

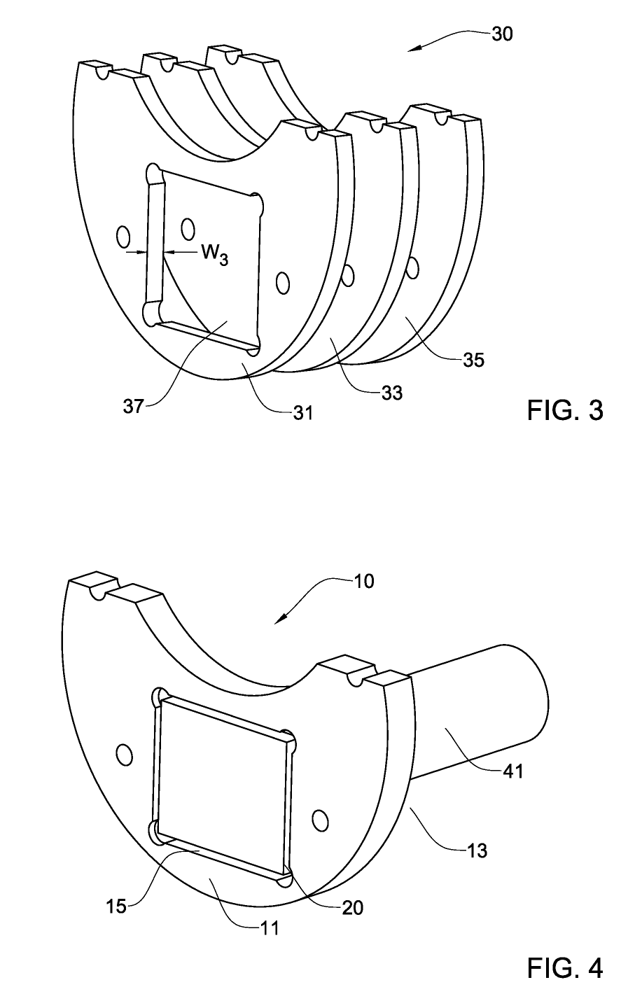

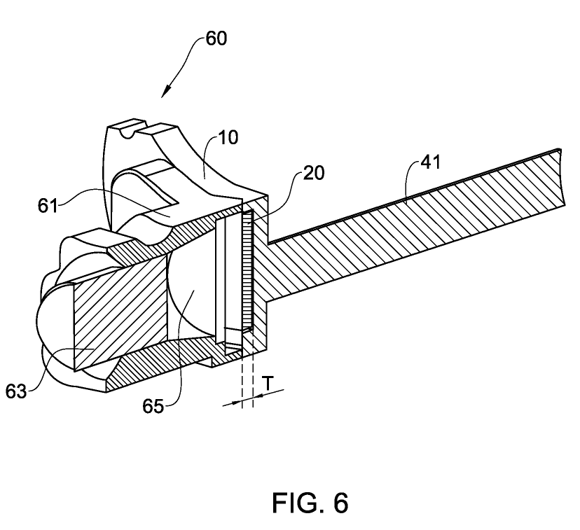

FIG. 2 illustrates discrete components deployed on the PCB, namely, a chip 20 having bonding pads 22, and bonding pads 21 located on the front surface 11 of the PCB 10. The distance between the chip 20 and the closest thereto bonding pad 24 is designated D. The chip 20 has a length L₂, a width W₂ and a thickness T (shown in FIGS. 6 and 7). The chip 20 is mounted within the recess 15 by gluing in a manner that it is substantially flush with the front surface 11. The length L₁ and the width W₁ of the recess 15 are greater than the length L₂ and the width W₂ of the chip 20, respectively. Consequently, margins 23 of about 0.05-0.1 mm between the chip 20 and the inner side walls 17 of the recess made in the PCB 10 are created, the purpose of which is to allow small displacement of the chip 20 when it is being affixed within the recess 15.

FIG. 3 illustrates another embodiment of a PCB 30 according to the present invention. The PCB 30 comprises three layers: a top layer 31, an intermediate layer 33 and a bottom layer 35. The top layer 31 constitutes the forward face of the PCB 30, and a through going opening 37 is made thereinto, which can be obtained by drilling a cut-out therein, or by milling. The width W₃ of the top layer 31 is substantially equal to the thickness T of the chip 20, which is mounted within the through going opening 37 as previously described. The top and the bottom layers 31 and 35 may be made of dielectric material, e.g. epoxy glass FR4, and the intermediate layer 33 may be made of an electrically conductive material, e.g. copper.

The following description, although referring to the PCB 10, is applicable to the PCB 30 as well.

FIG. 4 illustrates the PCB 10 with the chip 20 mounted within the recess 15 while the chip 20 is flush with the front surface 11 of the PCB 10. A cable 41 is seen being connected to the PCB 10. The cable comprises signal lines for transferring signals to and from the chip 20 as well as a power line for energizing the chip 20 and the LEDs of the optical head, as will be further described.

In use, the chip 20 is electrically connected to the bonding pads 21 by electrical wires 26 (shown in FIG. 2), which are bonded to the bonding pads 22 on the chip 20 at their one end and to the bonding pads 21 of the PCB 20 at their other end.

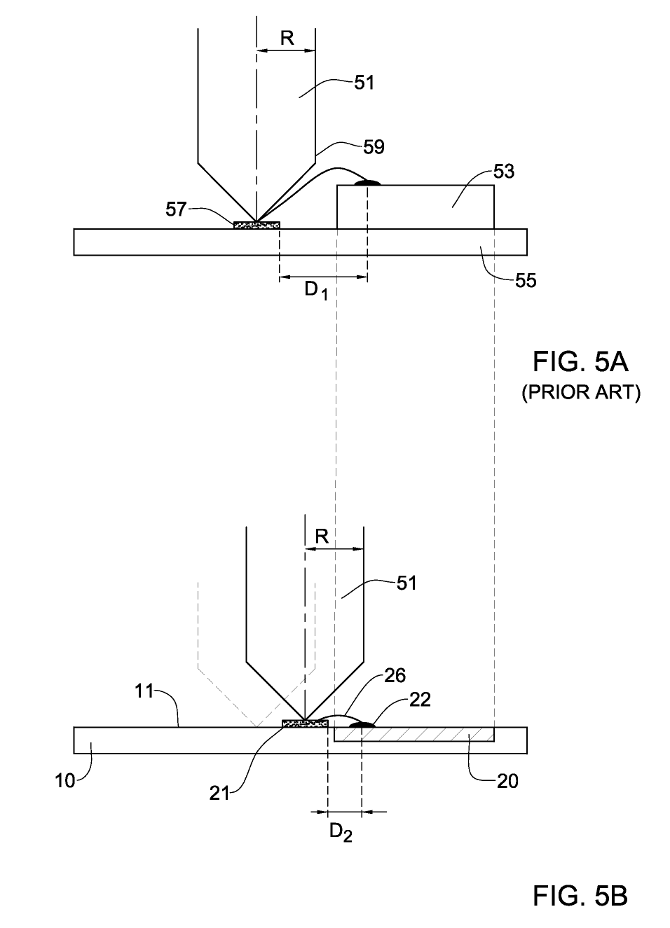

FIG. 5B illustrates a bonding process according to the present invention. A nozzle 51 of a bonding machine, having a radial dimension R, connects the bonding pad 21 to the corresponding bonding pad 22 of the chip 20. It is seen that the chip is flush with the front surface 11 of the PCB 10. By virtue of this provision the distance D₂ between the bonding pad 22 of the chip 20 and the bonding pad 21 of the PCB is not limited by the dimension R, and may be reduced below the radial dimension R, thereby reducing the overall size of the PCB 10. In practice the distance D₂ may be, for example, reduced from 045 mm (for a chip which is not flush) to about 0.15 mm.

FIGS. 6 and 7 illustrate the PCB 10 and the chip as they are used with an optical head 60 of an endoscope. FIG. 6 shows the main components of the optical head 60, namely, the PCB 10 with the chip 20 mounted therein, a lens retaining member 61, a filter 65 secured within the lens retaining member 61, and a lens 63. The PCB 10 is attached to the lens retaining member 61 by alignment pins (not shown) inserted in the alignment openings 19 (shown in FIGS. 1 to 4).

FIG. 7 illustrates the optical head 60 together with a disposable cap 70 put on a distal end of an insertion tube of an endoscope. The cap 70 is detachably connectable to a main body portion 71 of the optical head 60. Along the optical head 60 extends a multilumen tubing 73. The main body portion is provided with a dedicated U-like depression 75, through which extends the multilumen tubing and with a room 79, which has U-like cross sectional shape. Within the room 79 are received optical components of the optical head 60. The room 79 is located below the U-like depression such that the multilumen tubing is situated above the optical components. Among the optical components are, for example, lens 63 and illuminating means (not shown). The illuminating means, such as for example, two LEDs may be situated at the right and left side of the lens 63. The cap 70 comprises a butt end 72, which has a window 77a for the multilumen tubing 77, a window 63a for the lens 63 and a window 74a for passing light from the illuminating means. The above configuration of the optical head 60 is described in more details in Aizenfeld (International Patent Publication No. WO 2006/025058), which is incorporated herein by reference.

As shown in FIG. 7, the PCB 10 is part of the optical head 60 as previously described in FIG. 6. It can be also appreciated that the U-like cross-sectional shape of the room 79 dictates the U-shaped configuration of the PCB.

The invention is described in detail with reference to a particular embodiment, but it should be understood that various other modifications can be effected and still be within the spirit and scope of the invention.

We claim:

1. A printed circuit board (PCB) for deployment of a sensor chip of an optical head of an endoscope, the PCB comprising at least one layer defined by:
a front surface and a rear surface and having a recess provided on said front surface, said recess defined by inner walls and having a predefined depth dimension; wherein
the sensor chip having a thickness corresponding to said depth dimension of the recess, said sensor chip being receivable within the recess so as to be essentially flush with said front surface; and,
said PCB further comprising
at least one bonding pad located at a predetermined distance from the sensor chip; and
electrical wires for electrical connecting the sensor chip to the bonding pad.

2. A PCB according to claim 1, wherein the recess has length and width dimensions greater than corresponding length and width dimensions of the sensor chip, so as to create a margin between the sensor chip and the inner walls.

3. A PCB according to claim 1, further comprising at least two layers, one layer being a top layer and another layer being a bottom layer, said top layer having a cut-out defining said recess with said bottom layer.

4. A PCB according to claim 3, wherein the sensor chip has a thickness corresponding to a thickness of the top layer.

5. A PCB according to claim 1, wherein the sensor chip further comprises at least one bonding pad electrically connectable with the corresponding bonding pad of the PCB.

6. A PCB according to claim 1, wherein the sensor chip is a CCD-chip.

7. A PCB according to claim 1, further having a U-shape configuration.

8. An optical head for an endoscope having a printed circuit board (PCB) for deployment of a sensor chip, wherein the PCB comprising at least one layer which is defined by:
a front surface and a rear surface and
said layer having a recess provided on said front surface, said recess defined by inner walls and having a predefined depth dimension;
wherein said sensor chip having a thickness corresponding to said depth dimension of the recess, said sensor chip receivable within the recess so as to be essentially flush with said front surface; and
said PCB having at least one bonding pad located at a predetermined distance from the sensor chip, wherein said at least one pad being electrically connected to the sensor chip.

9. An optical head according to claim 8, wherein the recess has length and width dimensions greater than corresponding length and width dimensions of the sensor chip.

10. An optical head according to claim 8, wherein the PCB further comprises at least two layers, one layer being a top layer and another layer being a bottom layer, said top layer having a cut-out defining said recess with said bottom layer.

11. An optical head according to claim 10, wherein the sensor chip has a thickness corresponding to a thickness of the top layer.

12. An optical head according to claim 8, wherein the sensor chip further comprises at least one bonding pad electrically connectable with a corresponding bonding pad of the PCB.

13. An optical head according to claim 8, wherein the sensor chip is a CCD-chip.

14. An optical head according to claim 8, wherein the PCB has a U-shape configuration.

15. An endoscope having an optical head, comprising a printed circuit board (PCB), for deployment a sensor chip, the PCB comprising at least one layer, which is defined by:
a front surface, a rear surface and a recess disposed on said front surface and defined by inner walls, said recess having a predefined depth dimension;
wherein said sensor chip having a thickness corresponding to said depth dimension of the recess, said sensor chip being receivable within the recess so as to be essentially flush with said front surface; and
said PCB being provided with at least one bonding pad at a predetermined distance from the sensor chip and said at least one pad being electrically connectable to the sensor chip.

16. An endoscope according to claim 15, wherein the recess has length and width dimensions greater than corresponding length and width dimensions of the sensor chip, so as to create a margin between the sensor chip and the recess.

17. An endoscope according to claim 16, wherein the PCB further comprises at least two layers, one layer being a top layer and another layer being a bottom layer, said top layer having a cut-out defining said recess with said bottom layer.

18. An endoscope according to claim 17, wherein the sensor chip has a thickness corresponding to a thickness of the top layer.

19. An endoscope according to claim 15, wherein the sensor chip further comprises at least one bonding pad electrically connectable with the corresponding bonding pad of the PCB

20. An endoscope according to claim 15, wherein the sensor chip is a CCD-chip.

21. An endoscope according to claim 15, wherein the PCB has a U-shape configuration.

22. A method of connecting a sensor chip having a predetermined thickness to a printed circuit board (PCB) having a front surface and a rear surface, the method comprising:
providing a recess on said front surface, said recess having a predefined depth dimension, corresponding to said thickness;
deployment of the chip sensor within the recess so that the sensor chip is essentially flush with said front surface;
providing at least one bonding pad on said front surface at a predetermined distance from the sensor chip; and
electrically connecting the sensor chip to the at least one bonding pad.

23. A method according to claim 22, wherein the recess has length and width dimensions greater than corresponding length and width dimensions of the sensor chip, thereby creating a margin between the sensor chip and the PCB.

24. A method according to claim 22, wherein the PCB further comprises at least two layers, one layer being a top layer and another layer being a bottom layer, said top layer having a cut-out defining said recess with said bottom layer.

25. A method according to claim 24, wherein the sensor chip has a thickness corresponding to a thickness of the top layer.

26. A method according to claim 22, wherein the sensor chip is a CCD-chip.

27. A method according to claim 22, wherein the PCB has a U-shape configuration.
